(19) United States
(12) Patent Application Publication
(10) Pub. No.: US 2006/0146428 A1
(43) Pub. Date: Jul. 6, 2006

(54) Optical sheet for a display apparatus, method of manufacturing the same and display apparatus having the same

(76) Inventors: Jong-Sun Lim, Seoul (KR); Hyeong-Suk Yoo, Gyeonggi-do (KR); Weon-Sik Oh, Gyeonggi-do (KR); Sung-Chul Kang, Gyeonggi-do (KR)

Correspondence Address: McGuireWoods, Suite 1800, 1750 Tysons Boulevard,, McLean, VA, 22102, US

(21) Appl. No.: 10/535,237

(22) PCT Filed: Oct. 10, 2003
(86) PCT No.: PCT/KR03/02087

§ 371 Date: Dec. 16, 2005

(30) Foreign Application Priority Data
Nov. 18, 2002 (KR) 10-2002-0071660

(51) Int. Cl. G02B 5/04

(52) U.S. Cl. 359/833

(57) ABSTRACT

In an optical sheet (400) for a display apparatus, capable of improving luminance of a display image and a display quality, a method of manufacturing the same and a display apparatus having the same, the optical sheet (400) including a first medium (410) and a second medium (420) is disposed on a light pathway (430). The first medium (410) has a first reflective index. The second medium (420) has a second the first reflective index. The optical sheet (400) is disposed between the (100) or disposed on the display unit. The optical sheet (400) transmits a light without diffusion or loss of luminance. The light is generated from the backlight unit (100). The optical sheet (400) disposed on the display unit (200) scatters eternal light so as to display the image in high quality.

### TECHNICAL FIELD

The present invention relates to an optical sheet for a display apparatus, a method of manufacturing the same and a display apparatus having the same, and more particularly an optical sheet for a display apparatus, capable of improving luminance of a display image and a display quality, a method of manufacturing the same and a display apparatus having the same.

### BACKGROUND ART

A liquid crystal display (hereinafter, referred to as LCD) apparatus, generally, displays an image using liquid crystal.

A conventional LCD apparatus is disclosed in U.S. Pat. No. 6,380,998, which is entitled “LCD device having a backlight”. The LCD apparatus includes an LCD panel and a light supplying unit, called as a backlight assembly, so as to supply light to the LCD panel.

The LCD panel includes two electrodes opposite to each other, liquid crystal and a TCP (Tape Carrier Package). One of the two electrodes acts as a pixel electrode and the other of the two electrodes acts as a common electrode. The LCD apparatus, generally, has a plurality of pixel electrodes and one common electrode facing each of the pixel electrodes. The common electrode receives a reference voltage and each of the pixel electrodes receives a pixel voltage different from each other. The pixel electrodes are connected to thin film transistors (TFTs), respectively.

The liquid crystal is disposed between the common electrode and the pixel electrode. The liquid crystal has a light transmittance varied according to a voltage difference between the common electrode and the pixel electrode.

The TCP applies a driving signal to the TFTs so as to provide the pixel electrode with the driving signal.

The light supplying unit, generally, is disposed on a backside of the LCD panel so as to supply a light to the liquid crystal of the LCD panel. Particularly, the light supplying unit supplies the light to the liquid crystal, and the liquid crystal controls the light transmittance of the light. The light passed through the liquid crystal passes through a color filter, so that a user may recognize a color image displayed on the LCD panel. The light supplying unit includes a lamp that generates a light, a light guide plate that alters an optical distribution of the light and an optical sheet that diffuses and concentrates the light exited from the light guide plate. The light supplying unit may further include a plurality of optical sheets so as to display an image in high quality.

However, the light incident into the LCD panel may decreases while the light passes through the optical sheets, thereby decreasing the luminance of the light.

In U.S. Pat. No. 6,356,389, which is entitled “Subwavelength optical microstructure light collimating films”, a prism sheet has been disclosed as a representative optical sheet. The prism sheet partially concentrates a portion of a diffused light such that the diffused light enters an LCD panel.

Also, according to U.S. Pat. No. 6,354,709, which is entitled “Optical film”, a prism sheet partially concentrates light such that the light enters an LCD panel, but the prism sheet partially diffuses the light.

When the light diffuses in the prism sheet, the light may not be sufficiently supplied to the LCD panel, thereby deteriorating a luminance of an image displayed on the LCD panel.

### DISCLOSURE OF THE INVENTION

Accordingly, the present invention has been devised to solve the foregoing problems of the conventional art, and the present invention provides an optical sheet for a display apparatus, capable of improving a luminance by providing light to a display region without a loss of the light.

The present invention also provides a method of manufacturing an optical sheet, capable of improving a luminance by providing a light to a display region without a loss of the light.

The present invention also provides display apparatus capable of improving a luminance by providing a light to a display region without a loss of the light.

The optical sheet of the present invention includes a first medium and a second medium. The first medium has a light guide pathway disposed between a first region and a second region so as to transmit a light from the first region to the second region. The first medium has a first reflective index. The second medium is filled in the light guide pathway so as to reflect the light while the light passes through the light guide pathway and guide the light to the second region. The second medium has a second reflective index.

The method of manufacturing an optical sheet for a display apparatus of the present invention is provided as follows. A plurality of fiber optic pipes is bundled by contacting outer surfaces of the fiber optic pipes with each other, and each of the fiber optic pipes has a first length, a first end and a second end opposite to the first end. The bundled fiber optic pipes are then cut such that the bundled fiber optic pipes have a second length shorter than the first length.

The display apparatus of the present invention includes a backlight unit, a display unit and an optical sheet. The backlight unit generates a light in a first region. The display unit is disposed in a second region formed in a light guide pathway through which the light passes so as to display data using the light. The optical sheet is disposed on the light guide pathway, and the optical sheet has a first medium and a second medium. The first medium is disposed on the light guide pathway and has a first reflective index. The second medium is filled in the light guide pathway so as to emit the light incident into the light guide pathway without diffusion and has a second reflective index.

### BRIEF DESCRIPTION OF THE DRAWINGS

The above and other advantages of the present invention will become more apparent with reference to the following detailed description when considered in conjunction with the accompanying drawings wherein:

FIG. 1 is a schematic view showing an optical sheet for a display apparatus according to an exemplary embodiment of the present invention;

FIG. 2 is a schematic view showing an arrangement of a light guide pathway according to an exemplary embodiment of the present invention;

FIG. 3 is a schematic view showing an arrangement of a light guide pathway according to an exemplary embodiment of the present invention;

FIG. 4 is a schematic view showing a light reflected from a first medium and a second medium without loss or diffusion according to an exemplary embodiment of the present invention;

FIG. 5 is a schematic view showing relation between an optical sheet for a display apparatus, a first region and a second region according to an exemplary embodiment of the present invention;

FIG. 6 is a schematic view showing relation between an optical sheet for a display apparatus, a first region and a second region according to another exemplary embodiment of the present invention;

FIG. 7 is a schematic view showing an optical sheet for a display apparatus according to another exemplary embodiment of the present invention;

FIG. 8 is an enlarged view showing a portion “C” in FIG. 7;

FIG. 9 is a partially cut perspective view showing an optical sheet for a display apparatus according to another exemplary embodiment of the present invention;

FIGS. 10A to 10C are schematic views showing a light guide pathway according to another exemplary embodiment of the present invention;

FIG. 11 is a perspective view showing bundled fiber optic pipes for manufacturing an optical sheet for a display apparatus according to another exemplary embodiment of the present invention;

FIG. 12 is an enlarged view showing a portion “D” in FIG. 11;

FIG. 13 is a perspective view showing bundling fiber optic pipes from a plurality of fiber optic pipes according to another exemplary embodiment of the present invention;

FIG. 14 is a perspective view showing a process of attaching a fiber optic pipe to another fiber optic pipe covered with a bonding material according to another exemplary embodiment of the present invention;

FIG. 15 is a perspective view showing a process of cutting bundled fiber optic pipes according to another exemplary embodiment of the present invention;

FIG. 16 is an enlarged view showing a portion “E” in FIG. 15;

FIG. 17 is a cross-sectional view showing a fiber optic pipe from bundled fiber optic pipes according to another exemplary embodiment of the present invention;

FIG. 18 is a perspective view showing a process of polishing an end of an optical sheet for a display apparatus according to another exemplary embodiment of the present invention;

FIG. 19 is a schematic view showing a display apparatus according to another exemplary embodiment of the present invention;

FIG. 20 is a schematic view showing a TFT substrate according to another exemplary embodiment of the present invention;

FIG. 21 is a schematic view showing a color filter substrate according to another exemplary embodiment of the present invention;

FIG. 22 is a schematic view showing a relation between an optical sheet for a display apparatus and a pixel electrode according to another exemplary embodiment of the present invention; and

FIG. 23 is a schematic view showing an arrangement of an optical sheet for a display apparatus according to another exemplary embodiment of the present invention.

### BEST MODE FOR CARRYING OUT THE INVENTION

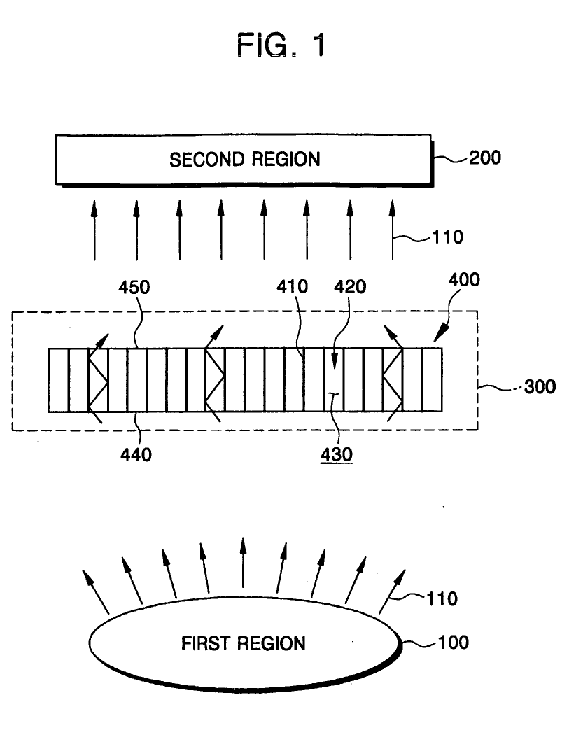

FIG. 1 is a schematic view showing an optical sheet for a display apparatus according to an exemplary embodiment of the present invention.

In exemplary embodiments described below, “first region” and “second region” refer to two areas divided by an optical sheet for a display apparatus.

That is, the first region is disposed on which a light is incident, and the second region is disposed on which the light is emitted.

Also, “light guide region” refers to an area disposed between the first region and the second region.

The first region, the second region and the light guide region are represented by reference numerals “100”, “200” and “300”, respectively.

An optical sheet 400 for a display apparatus is formed in the light guide region 300 sandwiched between the first region 100 and the second region 200.

Referring to FIG. 1, the optical sheet 400 for a display apparatus includes a first medium 410 and a second medium 420.

The first medium 410 has a first reflective index and a light guide pathway 430 so as to guide a light 110 generated from the first region 100 to the second region 200.

A light guide inlet 440 is a portion of the light guide pathway of the first medium in which the light is guided, and a light guide outlet 450 is a portion of the light guide pathway from which the light emits.

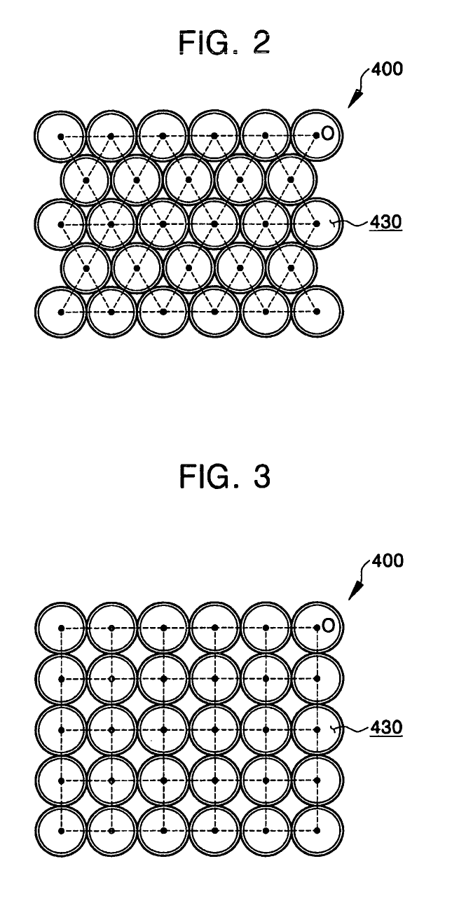

FIG. 2 is a schematic view showing an arrangement of a light guide pathway according to an exemplary embodiment of the present invention.

Referring to FIG. 2, centers of a plurality of light guide pathways 430 are arranged in a triangular shape when viewed on a plane that is substantially perpendicular to axes of the light guide pathways. When the centers of the light guide pathways are arranged in the triangular shape, number of the light guide pathways 430 may increase in a restricted area.

FIG. 3 is a schematic view showing an arrangement of a light guide pathway according to another exemplary embodiment of the present invention.

Referring to FIG. 3, the centers of a plurality of the light guide pathways 430 are arranged in a rectangangular shape when viewed on a plane that is substantially perpendicular to axes of the light guide pathways. When the centers of the light guide pathways are arranged in the rectangular shape, the light is divided into and arranged in a matrix shape to be transmitted effectively.

For example, pixels of an LCD apparatus are arranged in a matrix shape. Therefore, when the centers of the light guide pathways are aligned with the centers of the pixels, the light is supplied to the pixels more effectively.

The second medium 420 of FIG. 1 is filled in the light guide pathways 430. The second medium has a second reflective index, wherein the second reflective index of the second medium 420 is lower than the first reflective index of the first medium 410. Preferably, the second medium is air, and the reflective index of the second medium 420 is about 1.

A sidewall of the light guide pathway reflects the light 110 that is incident into the light guide inlet 440 in the second medium 420. Therefore, the light incident into the light guide inlet 440 is guided to the second region 200 without diffusion or loss in a light guide outlet 450.

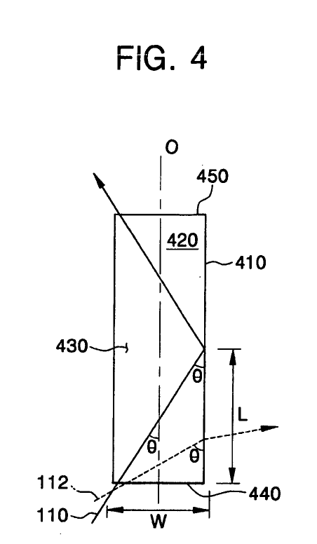

FIG. 4 is a schematic view showing a reflection of a light without loss or diffusion by a first medium and a second medium according to the exemplary embodiment for carrying out the present invention.

Referring to FIG. 4, a light 110 that is incident into the light guide inlet 440 at an angle θ with respect to the central axis O of the light guide pathway is reflected on an inner surface of the light guide pathway by a difference between the first reflective index of the first medium 410 and the second reflective index of the second medium so as to transmit the light to the light guide outlet 450, wherein θ is a reflection angle in the first medium 410.

A light that is incident into the light guide inlet 440 at an angle θ₁, which is greater than the θ with respect to the central axis O of the light guide pathway, is not reflected at the light guide pathway 430, but is transmitted to a neighboring light guide pathway. The light that has passed through the neighboring light guide pathway continues to advance until the angle with respect to the central axis O of the light guide pathway is smaller than θ. When the angle is smaller than θ, the light is reflected on the light guide pathway 430 so as to be transmitted to the light guide outlet 450.

A light incident into the light guide inlet 440 is transmitted to the light guide outlet 450 without reflection or permeation. The light incident into the light guide inlet 440 is in parallel to the central axis of the light guide pathway.

Referring to FIG. 4, a length of the first medium 410 is important. In order to reflect the light 110 incident into the light guide inlet 440 at an angle θ on an inner surface of the light guide pathway, a length needed to reflect the light incident into the light guide pathway 430 more than once is expressed as Equation 1, in which W denotes the width of the light guide pathway, the θ denotes an angle between the light 110 incident into the light guide pathway and an axis of the light guide pathway.
L=W/tan θ Equation 1

When the length of the first medium 410 is longer than L, a volume occupied by the first medium 410 increases. However, when the length of the first medium 410 is shorter than L, a volume occupied by the first medium 410 decreases and a light guide efficiency of the first medium 410 also decreases.

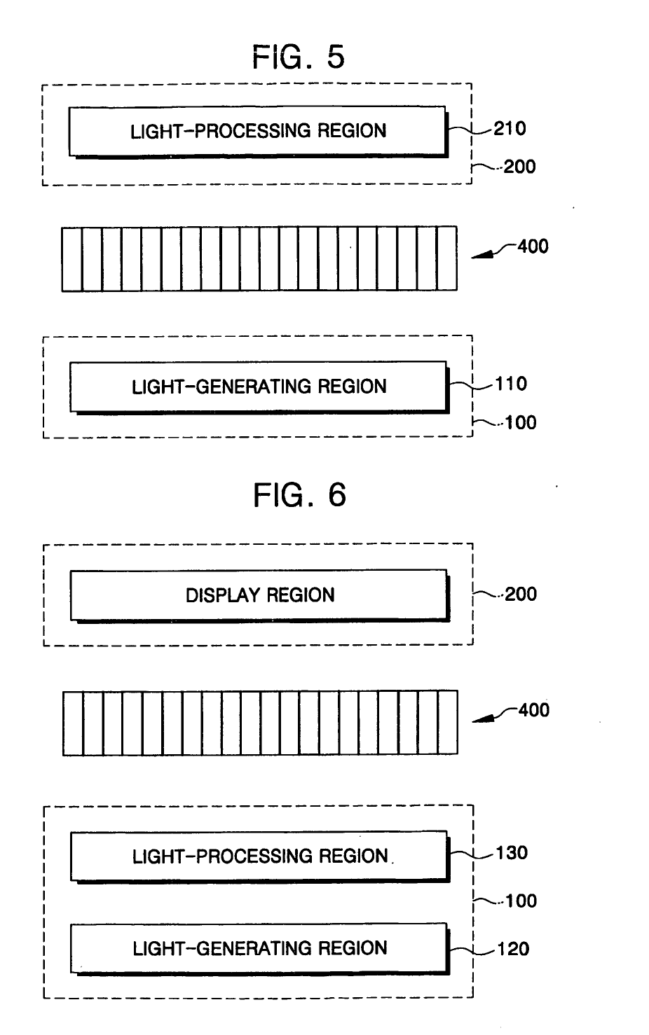

FIG. 5 is a schematic view showing a relation between an optical sheet for a display apparatus, a first region and a second region according to an exemplary embodiment of the present invention.

Referring to FIG. 5, the optical sheet 400 for a display apparatus is disposed between the first region 100 and the second region 200.

The first region 100 includes a light-generating region, and the second region 200 includes a light-processing region. The light-generating region and the light-processing region are represented by reference numerals “110” and “210”, respectively.

The light-generating region 110 is a region from which a light is supplied into the optical sheet 400 for a display apparatus. For example, the light-generating region 110 includes a backlight assembly that supplies a light into the LCD apparatus so as to display an image.

The light-processing region 210 is a region to which a light is supplied from the optical sheet 400 for a display apparatus. An LCD panel may be disposed in the light-processing region 210. The light is supplied to the LCD panel from the light-generating region 110 so as to display an image.

The optical sheet 400 transmits the light generated from the light-generating region 110 to the light-processing region 210, and the optical sheet 400 for a display apparatus suppresses both loss and diffusion of the light, thereby luminance in the light-processing region 210 being maximized. The optical sheet 400 is disposed between the light-generating region 110 and the light-processing region 210.

FIG. 6 is a schematic view showing a relation between an optical sheet for a display apparatus, a first region and a second region according to another exemplary embodiment of the present invention.

Referring to FIG. 6, the optical sheet 400 for a display apparatus is disposed between the first region 100 and the second region 200.

The first region 100 includes a light-generating region 120 and the second region 200 includes a display region 220.

A light is supplied in a direction to the optical sheet for the display region in the light-generating region 120 of the first region 100. For example, the backlight assembly of the LCD apparatus that supplies a light so as to display an image is disposed in the light-generating region 120. The light generated from the light-generating region 120 so as to display an image is supplied to the LCD panel disposed in the light-processing region 130.

After an image processed in the light-processing region 130 passes through the optical sheet for a display apparatus, the image is displayed in the display region 220 of the second region 200.

The optical sheet 400 for a display apparatus disposed between the light-processing region 130 and the display region 220 scatters an external light incident into the light-processing region 130 from the display region 220. The image is transmitted to the display region without scattering or diffusion, wherein the image is processed in the light-processing region 130 and passes through the optical sheet for a display apparatus.

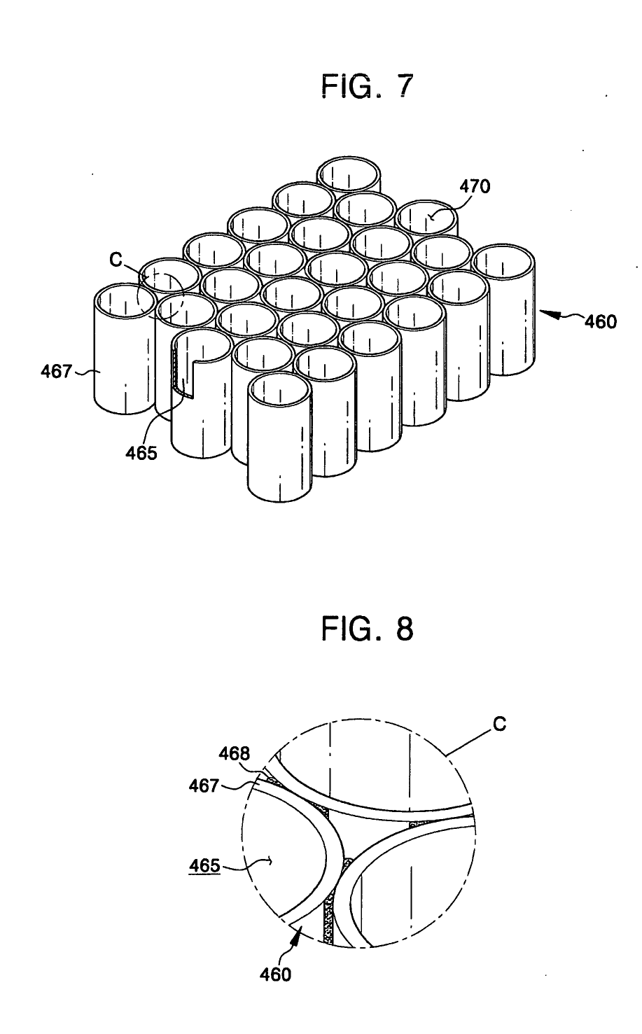

FIG. 7 is a schematic view showing an optical sheet for a display apparatus according to another exemplary embodiment of the present invention. Referring to FIG. 7, the optical sheet 400 for a display apparatus may be disposed between the light-generating region 110 and the light-processing region 210 as shown in FIG. 5, or between the light-processing region 130 and the display region 220 as shown in FIG. 6.

Referring to FIG. 7, the optical sheet 400 for a display apparatus includes a first medium 460 and a second medium 470.

The first medium 460 includes a plurality of fiber optic pipes. Each of the fiber optic pipes has a core that acts the light guide pathway 465 and a cladding 467 that surrounds the core. The cladding 467 contacts an adjacent cladding. Each of the fiber optic pipes are represented by a reference numeral “460”. A plurality of claddings 467 is arranged in parallel. The claddings 467 have the first reflective index. Preferably, the heights of the fiber optic pipes 460 are substantially the same, and the claddings 467 of the fiber optic pipes 460 are disposed so as to contact each other. The fiber optic pipes 460 are arranged in a sheet shape, for example, a rectangle shape when viewed on a plane that is substantially perpendicular to axes of the fiber optic pipes.

The claddings 467 of the first medium 460 include a material such as polymethlymethacrylate (PMMA), polycarbonate, quartz, etc. PMMA and polycarbonate are preferable because PMMA and polycarbonate are easy to cut and polish.

FIG. 8 is an enlarged view showing a portion “C” of FIG. 7. Referring to FIG. 8, the claddings 467 of the fiber optic pipes 460 are bonded with each other by means of a bonding material 468. The bonding material 468 includes coal tar. The claddings 467 may be coated by means of a bonding material over the contacted outer surface of the fiber optic pipes or a whole surface of the fiber optic pipes.

Referring to FIGS. 2 and 3, centers of the fiber optic pipes 460 are arranged in a triangular shape or a rectangular shape when viewed on a plane that is substantially perpendicular to axes of the fiber optic pipes.

The second medium 470 has a second reflective index that is lower than the first reflective index, and is filled in the light guide pathway 465. Preferably, the second medium 470 is air filled in the light guide pathway 465, and the second reflective index is 1.

The fiber optic pipes 460 of the optical sheet 400 for a display apparatus guide a light generated from a first region 100 to a second region 200 without diffusion or loss of the light.

Referring to FIG. 5, the optical sheet 400 for a display apparatus is disposed between the light-generating region 10 and the light-processing region 210, and the light generated from the light-generating region 110 is divided into each of the fiber optic pipes 460. The light exited from the fiber optic pipes 460 is reflected on an inner surface of the claddings of the fiber optic pipes 460 so as to be incident into the light-processing region 210. The light emitted from the fiber optic pipes 460 is incident into the light-processing region 210 without diffusion or loss.

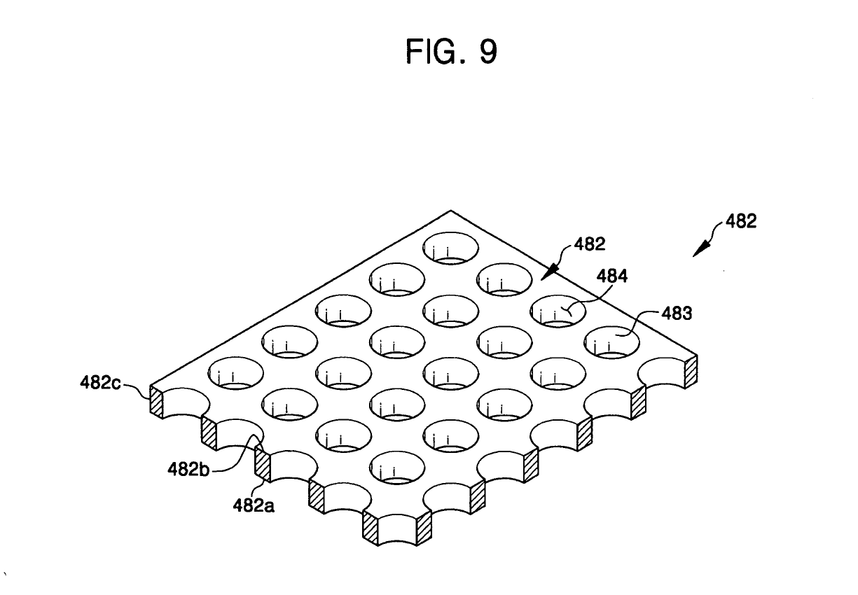

FIG. 9 is a partially cut perspective view showing an optical sheet for a display apparatus according to another exemplary embodiment of the present invention.

Referring to FIG. 9, the optical sheet 400 for a display apparatus includes a first medium 482 and a second medium 484.

The first medium 482 has a flat cubic shape. The first medium 482 is a light guide plate having light guide pathways 483. Hereinafter, the light guide plate is represented by a reference numeral “482”.

The light guide plate 482 includes polymethlymethacrylate (PMMA) or polycarbonate. The light guide plate 482 has a first reflective index.

The light guide plate 482 has a cubic shape, and the light guide plate 482 includes an inlet surface 482a, an outlet surface 482b opposite to the inlet surface 482a and a plurality of side surfaces 482c.

The light guide pathway 483 is an opening so as to connect the inlet surface 482a to the outlet surface 482b. A plurality of light guide pathways 483 is formed in the light guide plate 482. The centers of the light guide pathway may be arranged in a triangular shape as shown in FIG. 2 or a rectangular shape as shown in FIG. 3.

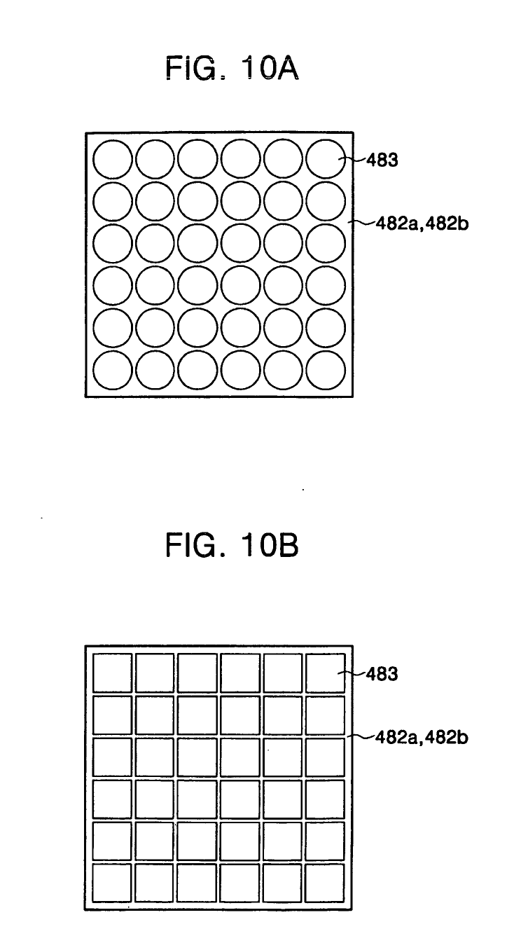

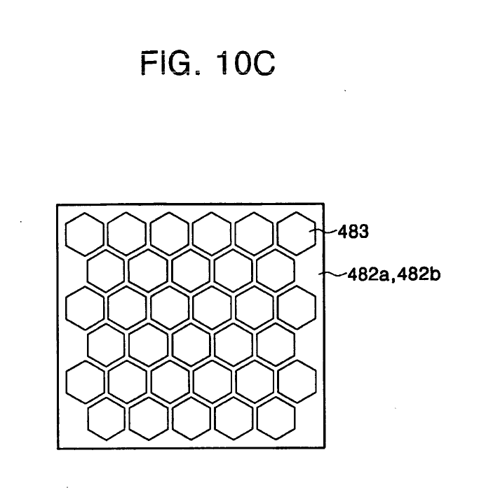

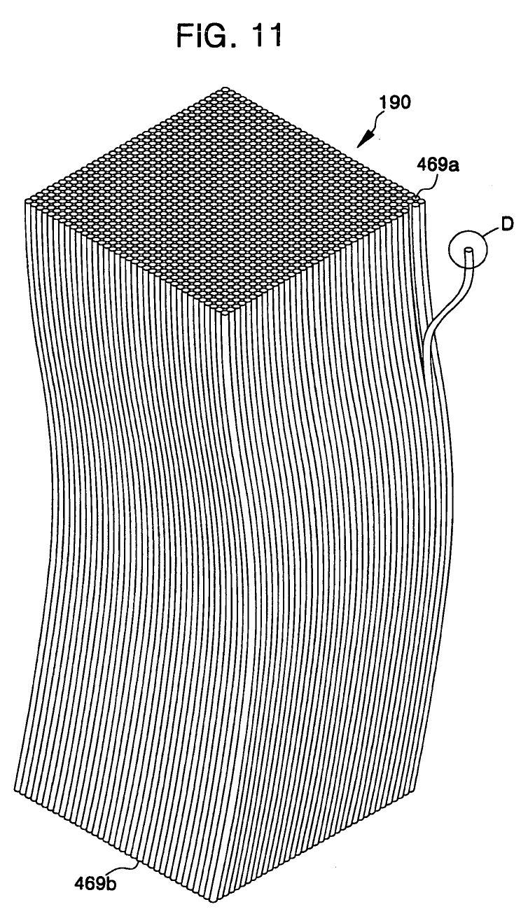

FIGS. 10A to 10C are schematic views showing a light guide pathway according to another exemplary embodiment of the present invention.

Referring to FIGS. 10A to 10C, the light guide pathway 483 may be arranged in a triangular shape, a rectangular shape or a polygonal shape at the inlet surface 482a and the outlet surface 482b. Also, the light guide pathway 483 has a cylindrical shape, a triangular prism shape, a rectangular prism shape or a polygonal prism shape when viewed on a plane that is substantially perpendicular to axes of the light guide pathway. Thereby, a light emitted from the light guide pathway 483 may also be arranged in the cylindrical shape, the rectangular prism shape or the polygonal prism shape.

Hereinafter, a method of manufacturing the optical sheet for a display apparatus according to another exemplary embodiment of the present invention are described with reference to the accompanying drawings.

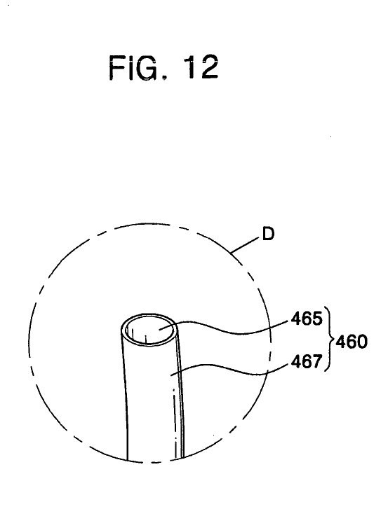

FIG. 11 is a perspective view showing bundled fiber optic pipes so as to manufacture an optical sheet for a display apparatus according to another exemplary embodiment of the present invention, and FIG. 12 is an enlarged view showing a portion “D” of FIG. 11.

Referring to FIG. 11 and FIG. 12, bundled fiber optic pipes include the fiber optic pipes 460, and each of the fiber optic pipes 460 has a light guide pathway 476 having a core, a cladding 467 and a first length. The fiber optic pipe 460 has a first end 469a and a second end 469b opposite to the first end 469a. The first length may be longer than a width of the fiber optic pipe.

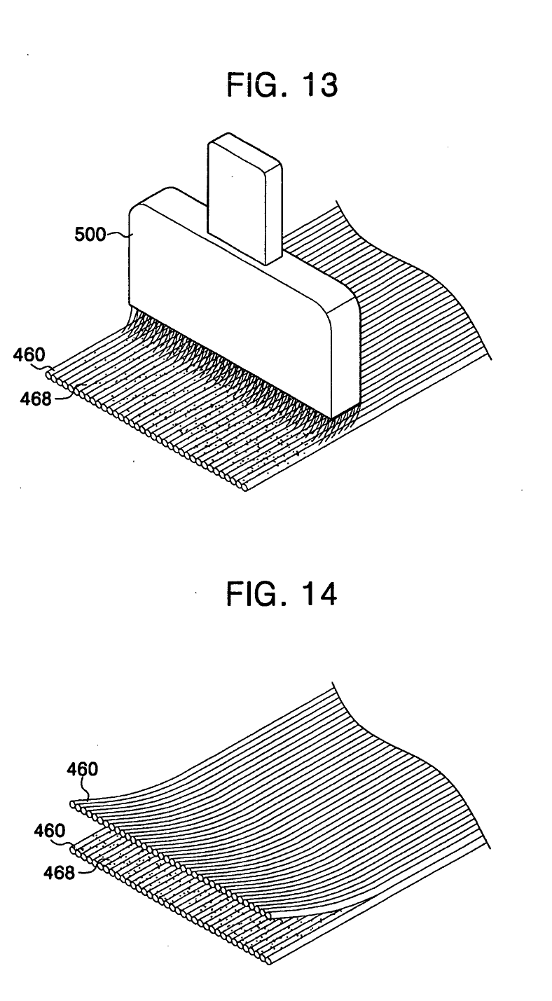

FIG. 13 is a perspective view showing bundling fiber optic pipes from a plurality of fiber optic pipes according to another exemplary embodiment of the present invention.

Referring to FIG. 13, the fiber optic pipes 460 make contact with each other in parallel to form a layer. A contacted portion of the fiber optic pipes 460 is coated by means of a bonding material 468. A brush 500 may be used to coat the contacted portion of the fiber optic pipes. The bonding material 468 includes coal tar.

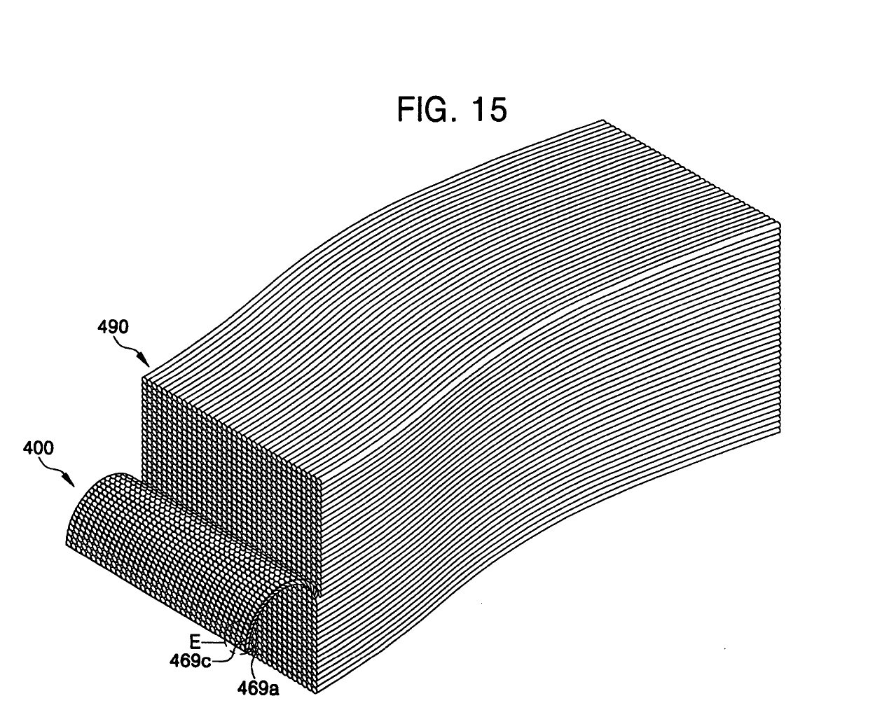

FIG. 14 is a perspective view showing a process of attaching a fiber optic pipe to another fiber optic pipe covered with a bonding material according to another exemplary embodiment of the present invention.

Referring to FIG. 14, the fiber optic pipes 460 covered with the bonding material 468 are disposed on another fiber optic pipes 460 without the bonding material 468 in parallel. The process is repeated to bundle the fiber optic pipes 460. The fiber optic pipes 490 are bonded with each other. The bundled fiber optic pipes 490 have substantially the same length as the fiber optic pipe 460.

Also, the bundled fiber optic pipes 490, centers of the fiber optic pipes 460 and axes of the fiber optic pipes 460 are arranged in a triangular shape or a rectangular shape when viewed on a plane that is substantially perpendicular to the axes.

FIG. 15 is a perspective view showing a process of cutting bundled fiber optic pipes according to another exemplary embodiment of the present invention.

Referring to FIG. 15, the bundled fiber optic pipes 490 are cut by a cutter such as a saw to form the optical sheet 400 for a display apparatus.

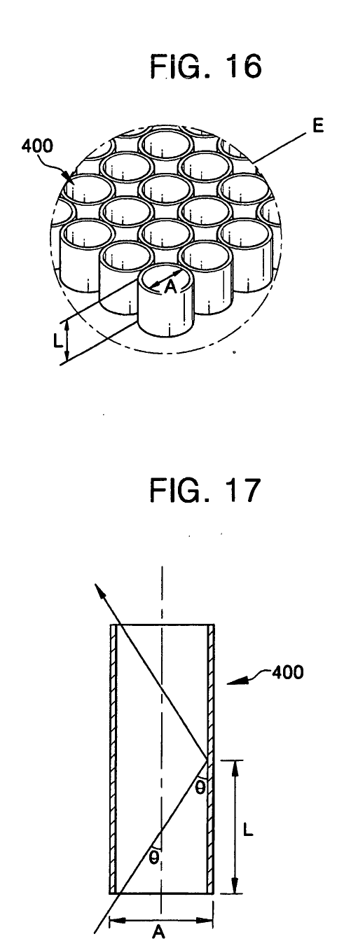

FIG. 16 is an enlarged view showing a portion “E” of FIG. 15, and FIG. 17 is a cross-sectional view showing a fiber optic pipe from bundled fiber optic pipes according to another exemplary embodiment of the present invention.

Referring to FIG. 16 and FIG. 17, the optical sheet 400 for a display apparatus is cut to be a second length L. The second length L is represented by the following Equation 2.
L=W/tan θ Equation 2

Here, W denotes a diameter of the fiber optic pipe 460, and θ denotes an angle between the light incident into the light guide pathway and an axis of the light guide pathway.

When the second length L of the optical sheet 400 for a display apparatus is too long, a thickness of the optical sheet 400 for a display apparatus also increases, thereby increasing a volume of the display apparatus. However, when the second length L of the optical sheet 400 for a display apparatus is too short, the light is not reflected on the cladding of the optical sheet for a display apparatus, thereby deteriorating display efficiency thereof.

The second length L of the optical sheet 400 for a display apparatus may be determined by a simulation.

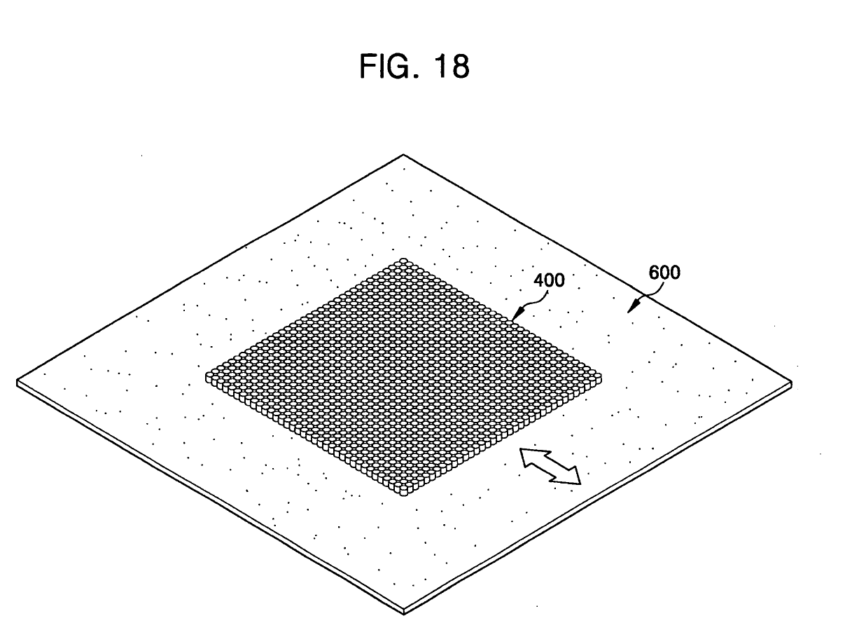

FIG. 18 is a perspective view showing a process of polishing an end of an optical sheet for a display apparatus according to another exemplary embodiment of the present invention.

Referring to FIG. 15 and FIG. 18, the optical sheet for a display apparatus has the first end 469a and a third end 469c formed by cutting. The optical sheet for a display apparatus is formed by means of cutting the bundled fiber optic pipes 490. The surface of the third end 469c is coarse. The third end 469c or the first end 469a is polished after the cutting.

Hereinafter, another exemplary embodiment of a display apparatus having an optical sheet for a display apparatus are described with reference to the accompanying drawings.

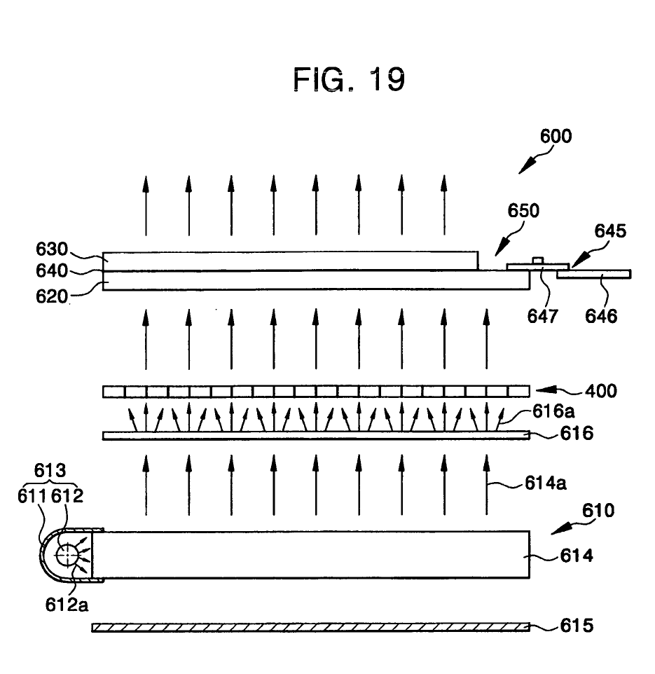

FIG. 19 is a schematic view showing a display apparatus according to another exemplary embodiment of the present invention.

Referring to FIG. 19, the display apparatus 600 includes a backlight unit 610, a display unit 650 and an optical sheet 400 for a display apparatus. Here, the optical sheet 400 for a display apparatus is disposed between the backlight unit 610 and the display unit 650.

The backlight unit 610 may include a lamp assembly 613, a light guide plate 614, a reflecting plate 615 and optical sheets 616.

The lamp assembly 613 includes a lamp cover 611 and a lamp 612. Preferably, the lamp 612 is a cathode-ray tube of cold type, is configured as a long circular cylinder and generates a white light in a radial direction. The lamp cover 611 reflects the white light so that the white light is emitted to a predetermined direction.

The light guide plate 614 is connected to the lamp cover 511 so as to receive the light generated from the lamp 612. The light guide plate 614 is configured as a wedge shape or a flat cubic shape. The light guide plate 614 changes a direction of a light 612a generated from the lamp 612, or changes an optical distribution from linear to planar. That is, a luminance distribution of the light 612a becomes uniform by means of the light guide plate 614. The light emitted from the light guide plate 614 is represented by a reference numeral “614a”.

The reflecting plate 615 is disposed on a rear surface of the light guide plate. The reflecting plate 615 reflects a leaked light of the rear surface of the light guide plate to the light guide plate 614. A luminance of the light generated from the lamp 612 is maintained by means of the reflecting plate 615.

The optical sheets 616 are disposed on a fore surface of the light guide plate so as to improve an optical distribution of the light 614a emitted from the light guide plate 614. A light emitted from the optical sheets 616 is represented by a reference numeral “616a”.

The optical sheets 616 may have composite sheets. For example, the optical sheets 616 include a diffusion sheet that diffuses the light 614a emitted from the light guide plate 614 and a sheet so as to improve luminance.

A display unit 650 is disposed on a path of the light 612a generated from the backlight unit 610.

Referring to FIG. 19, the display unit 659 is divided into a TFT (thin film transistor) substrate 620, a color filter substrate 630, liquid crystal 640, and a driving module 645. The liquid crystal 640 is disposed between the TFT substrate 620 and the color filter substrate 630.

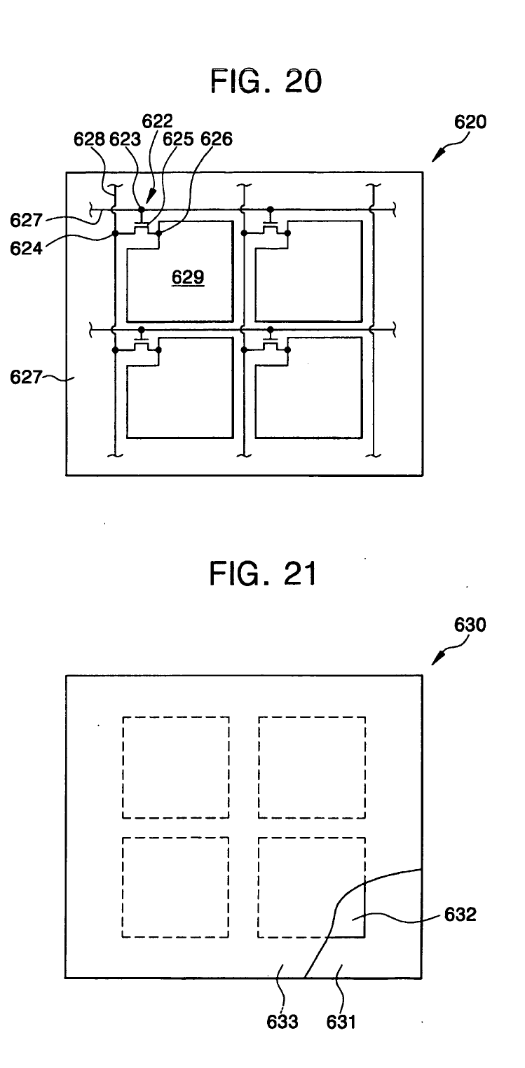

FIG. 20 is a schematic view showing a TFT substrate according to another exemplary embodiment of the present invention.

Referring to FIG. 20, the TFT substrate 620 includes a first transparent substrate 621, thin film transistors 622, gate lines 627, data lines 628 and pixel electrodes 629.

The thin film transistors 622 are disposed on the first transparent substrate 621 and arranged in a matrix shape. The thin film transistor 622 includes a gate electrode 623, a channel layer 625, a source electrode 624 and a drain electrode 626.

The gate line 627 and the data line 628 are connected to the gate electrode 623 and the source electrode 624, respectively.

The pixel electrode 629 is connected to the drain electrode 626 of the thins film transistor 622. As the thin film transistor 622 is arranged in a matrix shape, the pixel electrode 629 is arranged in a matrix shape. The pixel electrode 629 includes indium tin oxide or indium zinc oxide. Both the indium tin oxide and the indium zinc oxide are transparent and conductive.

FIG. 21 is a schematic view showing a color filter substrate according to another exemplary embodiment of the present invention.

Referring to FIG. 21, the color filter substrate 630 includes a second transparent substrate 631, color filters 632 and a common electrode 633.

The second transparent substrate 631 is opposite to the first transparent substrate 621. The color filters 632 and the common electrode 633 are formed on the second transparent substrate 631.

The color filters 632 are formed on an opposite surface to the first transparent substrate 621. The color filter 632 includes a red color filter, a green color filter and a blue color filter. The red color filter transmits a light of red wavelength, the green color filter transmits a light of green wavelength and the blue color filter transmits a light of blue wavelength.

The common electrode 633 is formed over the second transparent substrate 631 on which the color filter 632 is formed. The common electrode 633 includes indium tin oxide or indium zinc oxide.

The liquid crystal 640 is disposed between the TFT substrate 620 and the color filter substrate. The liquid crystal 640 changes a light permeability according to field intensity. The field intensity is formed between the pixel electrode 629 and the common electrode 633. The pixel electrode 629 is formed on the TFT substrate 620 and the common electrode 633 is formed on the color filter substrate 630.

Predetermined field intensity is applied on the common electrode 633. Therefore, the light permeability of the liquid crystal 640 may be controlled by means of the field intensity applied on the pixel electrode 629.

Referring to FIG. 19, the driving module 645 includes a printed circuit board 646 and a tape carrier package 647. The printed circuit board 646 transforms an image signal into a driving signal for a display apparatus. The image signal is generated from an exterior computer (not shown). The tape carrier package 647 applies the driving signal on the thin film transistor 622 of the TFT substrate 620 according to a predetermined time. The driving signal is generated from the printed circuit board 646.

Referring to FIG. 19, the optical sheet 400 for a display apparatus is disposed on a path of a light 614a that is emitted from the light guide plate 614 of the backlight unit 610.

Hereinafter, an optical sheet for a display apparatus is disclosed in another exemplary embodiment of the present invention. An optical sheet 400 for a display apparatus is substantially the same as mentioned above.

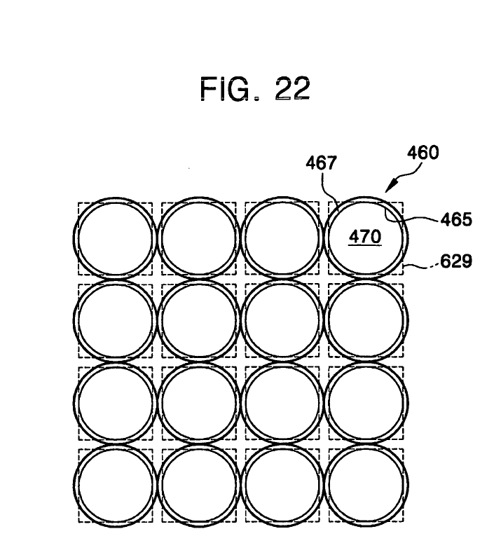

FIG. 22 is a schematic view showing relation between an optical sheet for a display apparatus and a pixel electrode according to another exemplary embodiment of the present invention.

Referring to FIG. 22, each of fiber optic pipes 460 of the optical sheet 400 for a display apparatus is formed corresponding to each of the pixel electrodes 629 in FIG. 20. After a light emitted from a light guide plate 614 enters a light guide pathway 576 of a fiber optic pipe 460, the light 614a emitted from the light guide plate 614 is reflected on an inner surface of a cladding 467. The reflected light is then guided into the display unit 650.

The light guided into the display unit 650 is then supplied into each of the pixel electrodes 629 arranged in a matrix shape on the display unit 650. After the light supplied into the pixel electrode 629 passes through a liquid crystal, the light then passes through the color filter 632. An arrangement of the liquid crystal is changed by a field difference between the pixel electrode 629 and the common electrode 633. And the light is then incident into eyes of a user. Therefore, high quality image having high luminance is obtained.

Hereinafter, another exemplary embodiment of a display apparatus having an optical sheet for a display apparatus are described with reference to the accompanying drawings.

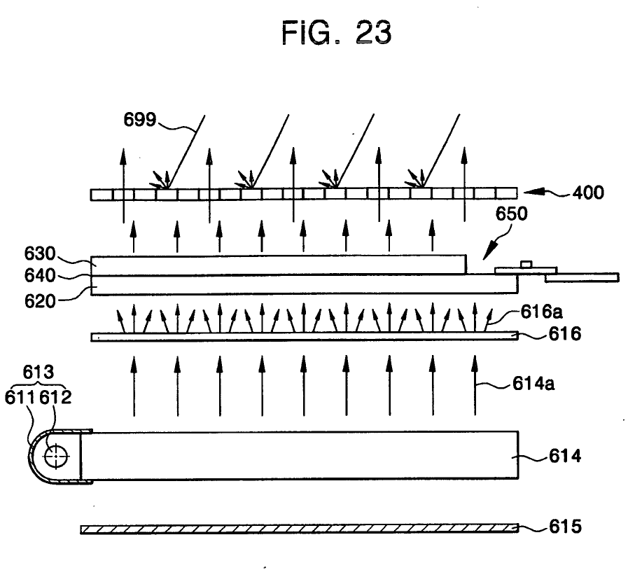

FIG. 23 is a schematic view showing arrangement of an optical sheet for a display apparatus according to another exemplary embodiment of the present invention.

An optical sheet 400 for a display apparatus may be formed on the display unit 650. The optical sheet 400 for a display apparatus is substantially the same as mentioned above.

The optical sheet 400 for a display apparatus is formed over the display unit 650, and transmits a light to eyes of a user. The light passes through the liquid crystal 640 of the display unit 650 and a color filter of a light guide plate 614. An external light 699 is also transmitted to the eyes of the user. The external light 699 has no image. When the external light 699 without the image is transmitted to the eyes of the user, the external light 699 deteriorates quality of the image.

The optical sheet 400 for a display apparatus scatters the external light 699 to prevent the external light 699 from being incident into the eyes of the user, thereby creating high quality display.

### INDUSTRIAL APPLICABILITY

As mentioned above, a luminance of a display apparatus is improved, thereby improving quality of a display image. Also, luminance is maintained by means of scattering of an external light, thereby improving display quality.

Although another exemplary embodiment of the present invention have been described, it is understood that the present invention should not be limited to another exemplary embodiment but various changes and modifications can be made by one ordinary skilled in the art within the spirit and scope of the present invention as hereinafter claimed.

1. An optical sheet for a display apparatus comprising:
a first medium having a light guide pathway disposed between a first region and a second region so as to transmit a light from the first region to the second region, the first medium having a first reflective index; and
a second medium being filled in the light guide pathway so as to reflect the light while the light passes through the light guide pathway and to guide the light to the second region, the second medium having a second reflective index.

2. The optical sheet of claim 1, wherein the first medium comprises a plurality of light guide pathways, and centers of the light guide pathways adjacent to each other are arranged in a triangular shape or a rectangular shape when viewed on a plane that is substantially perpendicular to axes of the light guide pathways.

3. The optical sheet of claim 1, wherein the first reflective index is greater than the second reflective index.

4. The optical sheet of claim 3, wherein the second reflective index is about 1.

5. The optical sheet of claim 1, wherein the light guide pathway has a first length and the first length is longer than W/tan θ that represents a length needed to reflect the light incident into the light guide pathway more than once, in which W denotes a width of the light guide pathway and θ denotes an angle between the light incident into the light guide pathway and an axis of the light guide pathway.

6. The optical sheet of claim 1, wherein the first region is a light-generating region, and the second region is a light-processing region.

7. The optical sheet of claim 1, wherein the first region is a light-processing region, and the second region is a display region on which an image processed in the light-processing region is displayed.

8. The optical sheet of claim 1, wherein the first medium comprises a plurality of fiber optic pipes each having a core that acts as the light guide pathway and a cladding that surrounds the core, the cladding contacting an adjacent cladding.

9. The optical sheet of claim 8, wherein the fiber optic pipe comprises a material selected from the group consisting of polymethlymethacrylate (PMMA), polycarbonate and quartz.

10. The optical sheet of claim 8, wherein the fiber optic pipes are bonded with each other by means of a bonding material.

11. The optical sheet of claim 1, wherein the first medium comprises an optical plate having a plurality of light guide pathways.

12. The optical sheet of claim 11, wherein the light guide pathway has a cylindrical shape, a triangular prism shape, a rectangular prism shape or a polygonal prism shape.

13. A method of manufacturing an optical sheet for a display apparatus comprising:
bundling a plurality of fiber optic pipes by contacting outer surfaces of the fiber optic pipes with each other, each of the fiber optic pipes having a first length, a first end and a second end opposite to the first end; and
cutting the bundled fiber optic pipes such that the bundled fiber optic pipes have a second length shorter than the first length.

14. The method of claim 13, wherein the bundling the fiber optic pipes further comprises coating a bonding material over the contacted outer surface of the fiber optic pipes.

15. The method of claim 13, wherein the bundling the fiber optic pipes further comprises disposing the fiber optic pipes such that axes of the fiber optic pipes are arranged in a triangular shape when viewed on a plane that is substantially perpendicular to the axes.

16. The method of claim 13, wherein the bundling the fiber optic pipes further comprises disposing the fiber optic pipes such that axes of the fiber optic pipes are arranged in a rectangular shape when viewed on a plane that is substantially perpendicular to the axes.

17. The method of claim 13, wherein the second length is longer than W/tan θ that represents a length needed to reflect the light incident into the light guide pathway more than once, in which W denotes a width of the light guide pathway and θ denotes an angle between the light incident into the light guide pathway and an axis of the light guide pathway.

18. The method of claim 13, further comprising grinding the first end and a third end that is formed by cutting the bundled fiber optic pipes.

19. A display apparatus comprising:
a backlight unit that generates a light in a first region;
a display unit disposed in a second region formed in a light guide pathway through which the light passes so as to display data using the light; and
an optical sheet disposed on the light guide pathway, the optical sheet including a first medium and a second medium, the first medium being disposed on the light guide pathway and having a first reflective index, the second medium being filled in the light guide pathway so as to emit the light incident into the light guide pathway without diffusion and having a second reflective index.

20. The display apparatus of claim 19, wherein the first medium comprises a plurality of fiber optic pipes each having a core that acts the light guide pathway and a cladding that surrounds the core, the cladding contacting an adjacent cladding.

21. The display apparatus of claim 19, wherein the first medium comprises an optical plate on which a plurality of light guide pathways is formed.

22. The display apparatus of claim 19, wherein the light guide pathway has a cylindrical shape, a triangular prism shape, a rectangular prism shape or a polygonal prism shape.

23. The display apparatus of claim 19, wherein the display unit comprises:
a TFT substrate having a plurality of thin film transistors and a plurality of pixel electrodes, the thin film transistors being arranged on a first substrate, the pixel electrodes receiving a driving power from the thin film transistors;
a color filter substrate having a color filter and a common electrode, the color filter being disposed on a second substrate and facing the pixel electrodes, the common electrode formed over the second substrate; and
a liquid crystal disposed between the TFT substrate and the color filter substrate,
and wherein the light guide pathway is formed corresponding to each of the pixel electrodes.

24. The display apparatus of claim 19, wherein the optical sheet is disposed between the first region and the second region.

25. The display apparatus of claim 19, wherein the optical sheet is formed in a third region disposed between the first region and the second region.
